(19) United States
(12) Patent Application Publication
(10) Pub. No.: US 2016/0063776 A1
(43) Pub. Date: Mar. 3, 2016

(54) Method and Apparatus for Event Data Recording Activation and Logging

(71) Applicant: Ford Global Technologies, LLC, Dearborn, MI (US)

(72) Inventors: David Chronowski, Harrison Township, MI (US); Hussein F. Nasrallah, Dearborn, MI (US); Kevin Michael Bullister, Dexter, MI (US)

(21) Appl. No.: 14/472,652

(22) Filed: Aug. 29, 2014

(51) Int. Cl. G07C 5/08; B60Q 9/00; G07C 5/00

(52) U.S. Cl. CPC G07C 5/0841; G07C 5/008; B60Q 9/00

(57) ABSTRACT

A system includes a processor configured to detect a condition indicating that event data recording (EDR) should begin. The processor is further configured to begin and continue event data recording for a predetermined amount of time following the condition. Also, the processor is configured to save data recorded by the event data recording, if the predetermined amount of time has passed, and no severe incident has been detected. The processor is further configured to upload the data to a remote system once a connection with the remote system can be established.

### TECHNICAL FIELD

The illustrative embodiments generally relate to a method and apparatus for event data recording (EDR) activation and logging.

### BACKGROUND

Similar to a black box in an airplane, many vehicles come equipped with event data recorders that allow for recording of vehicle data when an accident occurs, which recording can help aid in determining vehicle characteristics (e.g., speed, parts malfunction, traction states, etc.) that may have lead to the accident. Currently, most EDRs are employed as a storage device to record a snapshot of data surrounding a crash event. Typically, EDRs have thresholds that determine when recording will begin. These thresholds typically relate to conditions likely to lead to an accident. In many cases, recordings are begun and then later over-written, because the vehicle operating mode breached one or more initiation thresholds, but no actual crash event occurred. In these cases, the EDR data is not locked for retrieval, and is overwritten by later EDR events when another threshold is breached.

U.S. Pat. No. 8,139,820 generally relates to exception event recorders and analysis systems including: vehicle mounted sensors arranged as a vehicle event recorder to capture both discrete and non-discrete data; a discretization facility; a database; and an analysis server all coupled together as a computer network. Motor vehicles with video cameras and onboard diagnostic systems capture data when the vehicle is involved in a crash or other anomaly (an ‘event’). In station where interpretation of non-discrete data is rendered, i.e. a discretization facility, captured data is used as a basis for production of supplemental discrete data to further characterize the event. Such interpreted data is joined to captured data and inserted into a database in a structure which is searchable and which supports logical or mathematical analysis by automated machines. A coupled analysis server is arranged to test stored data for prescribed conditions and upon finding such, to initiate further actions appropriate for the detected condition.

U.S. Application No. 2006/0212195 generally relates to a vehicle data recorder with the capability to continuously record and store selected data on both driver and vehicle performance that will include but not be limited to, miles driven, speed, acceleration/deceleration, brake activation, seatbelt usage, vehicle direction, steering anomalies, global position, impact forces and direction, transmission status, and alcohol usage. Specifically, this recorder will have extended data storage capacity, a drunk driver prevention smart ignition, real-time GPS data, low-power cell phone jamming, and internal wireless communication capabilities. It uses microprocessor controlled electronics to record, store, and transmit both driver and vehicle performance data in a date and time stamped file which can be utilized to establish personalized insurance rates, assess road tax and use fees, locate “Amber alert” victims or stolen vehicles, and with it's on scene access, provide critical mechanism of injury information to emergency responders.

### SUMMARY

In a first illustrative embodiment, a system includes a processor configured to detect a condition indicating that event data recording (EDR) should begin. The processor is further configured to begin and continue event data recording for a predetermine amount of time following the condition. Also, the processor is configured to save data recorded by the event data recording, if the predetermined amount of time has passed, and no severe incident has been detected. The processor is further configured to upload the data to a remote system once a connection with the remote system can be established.

In a second illustrative embodiment, a system includes a processor configured to receive variable input data from a plurality of wirelessly connected vehicles. The processor is further configured to compare the received variable input data to predetermined thresholds to determine if a condition likely to initiate event data recording (EDR) is imminent in any of the plurality of vehicles. Also, the processor is configured to issue an instruction for the vehicle to warn the vehicle driver, for each vehicle in which the condition is imminent. The processor is additionally configured to issue a request to each vehicle for which the condition is imminent, requesting event data recording. The processor was further configured to gather data recorded by the requested event data recording(s).

In a third illustrative embodiment, a computer-implemented method includes detecting a condition indicating that event data recording (EDR) should begin. The method further includes beginning and continuing event data recording for a predetermine amount of time following the condition. The method additionally includes saving data recorded by the event data recording, if the predetermined amount of time has passed, and no severe incident has been detected. The method also includes uploading the data to a remote system once a connection with the remote system can be established.

### BRIEF DESCRIPTION OF THE DRAWINGS

FIG. 1 shows an illustrative vehicle computing system;

FIG. 2 shows an illustrative example of EDR monitoring;

FIG. 3 shows an illustrative example of a driver alert process; and

FIG. 4 shows a further illustrative example of EDR monitoring.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

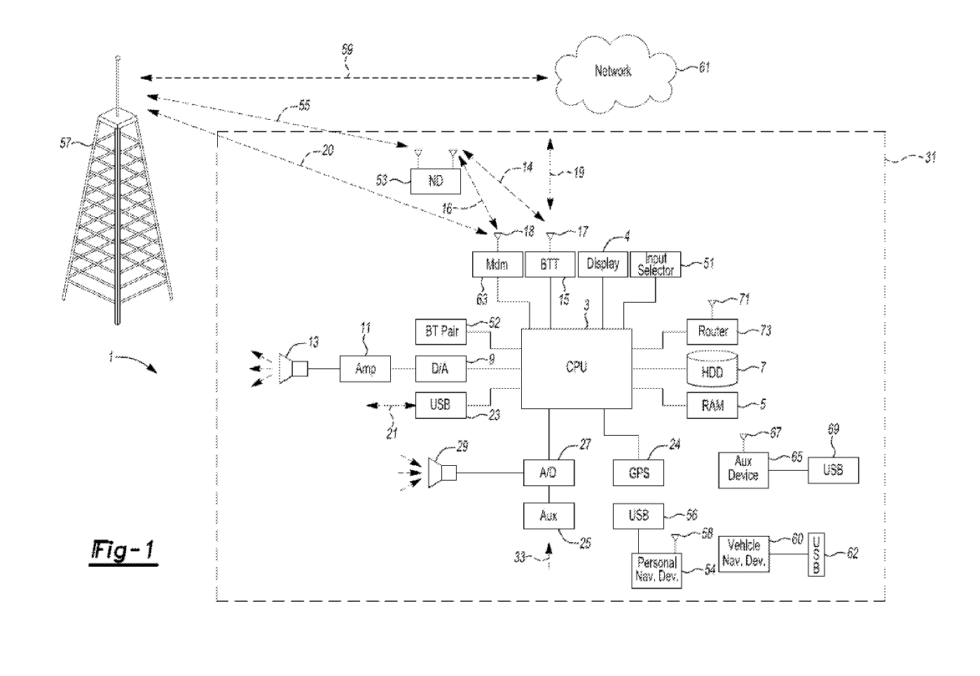

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

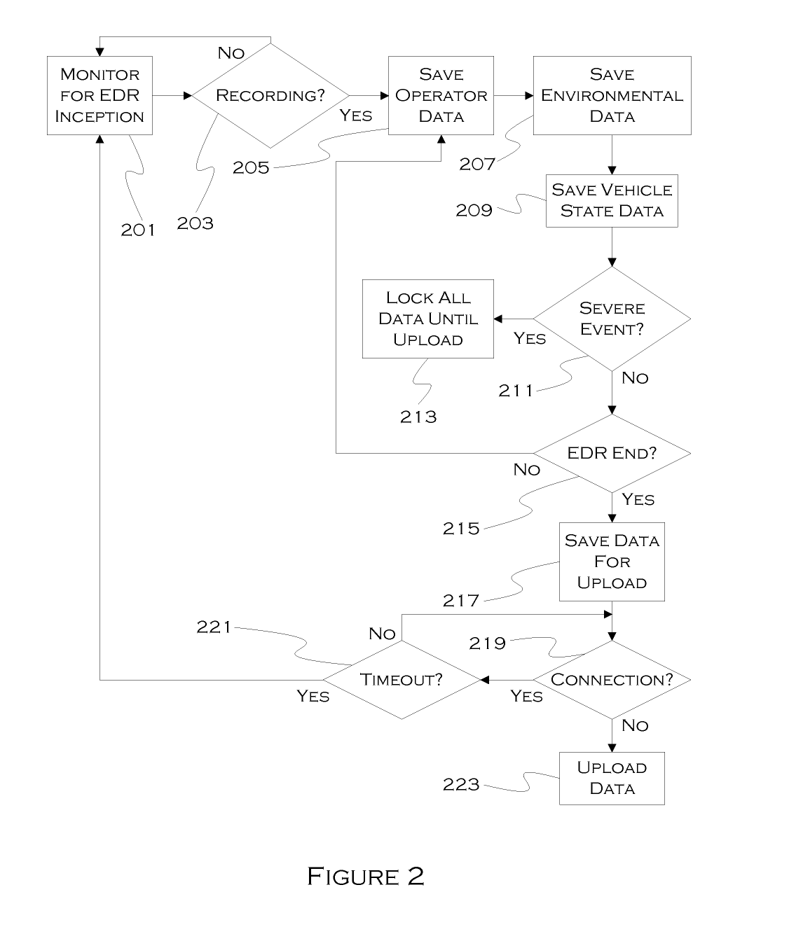

In the illustrative example shown in FIG. 2, an EDR monitoring process is shown. In most EDR triggering situations, the data saved by the EDR is discarded, because an actual accident requiring use of the EDR data does not occur. For example, without limitation, if a driver slams on the brakes of a vehicle, this sudden stop or a sudden pitch of the vehicle may trigger the EDR system.

Since it is desirable to gather data prior to an actual accident, the EDR system will frequently begin recording at some point prior to an accident. Since it is impossible to know when an actual accident will occur, the EDR system will generally begin recording when a precursor event that indicates a potential accident occurs. This could include, but is not limited to, vehicle moving out of control, rapid deceleration, vehicle pitching beyond a certain angle, or other events that indicate an accident is imminent.

If the accident does not result from the precursor event, the EDR will generally simply dump the data recorded, since no accident was detected, no data is needed to analyze the possible cause of the accident. But, in the illustrative embodiments, it is desirable to preserve the EDR data for future analysis.

By using saved EDR data, fleet operators can tell which drivers or vehicles come into close projected proximity to accidents. That is, the operators can determine which drivers or vehicles almost cause or end up in accidents, even if no accidents actually occur.

Also, by saving and analyzing EDR data, conditions that lead to pre-accident triggers can more easily be observed. For example, if certain wear on brakes results in vehicles having high EDR triggers, this can be more easily observed if additional EDR data is saved, other than when an actual accident occurs.

In the illustrative example shown in FIG. 2, the process monitors for inception of the EDR system 201. As previously noted, this can be, for example, any event or vehicle state that causes the EDR system to begin recording data. As long as the EDR system has not begun recording data 203, the process will continue to monitor for the onset of the recording state. Once the recording state has been triggered, the process continues.

With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

At the time the recording state begins, in this illustrative example, operator data is saved 205. This data can be used to evaluate certain operator's propensity for triggering EDR recording states. Such analysis may be useful to a fleet manager when reviewing personnel. Also saved is the environmental data measured by vehicle sensors and available from outside providers. For example, without limitation, precipitation states, temperatures, road friction conditions, and other environmental data can be monitored, to analyze which environmental data will commonly trigger, or aid in triggering, an EDR recording state (and thus a possible accident).

Vehicle state data is also saved 207 at this time, so that vehicle states can be observed. This can help determine which vehicle states (low fuel, low tire pressure, imbalanced load, etc.) might typically lead to the onset of EDR recording.

If a severe event (e.g., an accident) occurs 209, the process may then lock in all recorded data 213 for use by post-crash analysis technicians. This is similar to the current function of the EDR, where an accident will cause preservation of current EDR data.

If there is no severe event, but the EDR conditions for recording still persist 215, the process will continue to record all appropriate state data until the EDR recording conditions cease, or until a severe event occurs.

In the current EDR systems, once recording conditions cease, the system will delete the data, thus preventing analysis of the data in non-crash situations. In the illustrative embodiments, however, once the EDR system stops recording data, even if a severe event has not occurred, the process will save the data for later upload to a remote system for analysis.

If or when the local recording system is connected, through, for example, a vehicle computer using a wireless connection to a wireless phone to connect to the remote server, the process will upload the data 223 to the remote server. If a connection is not established 219, the process may attempt to establish a connection for some period of time 221. If the connection still is not established, the process may revert to monitoring and recording, and may upload the data at some future point, when a connection is established.

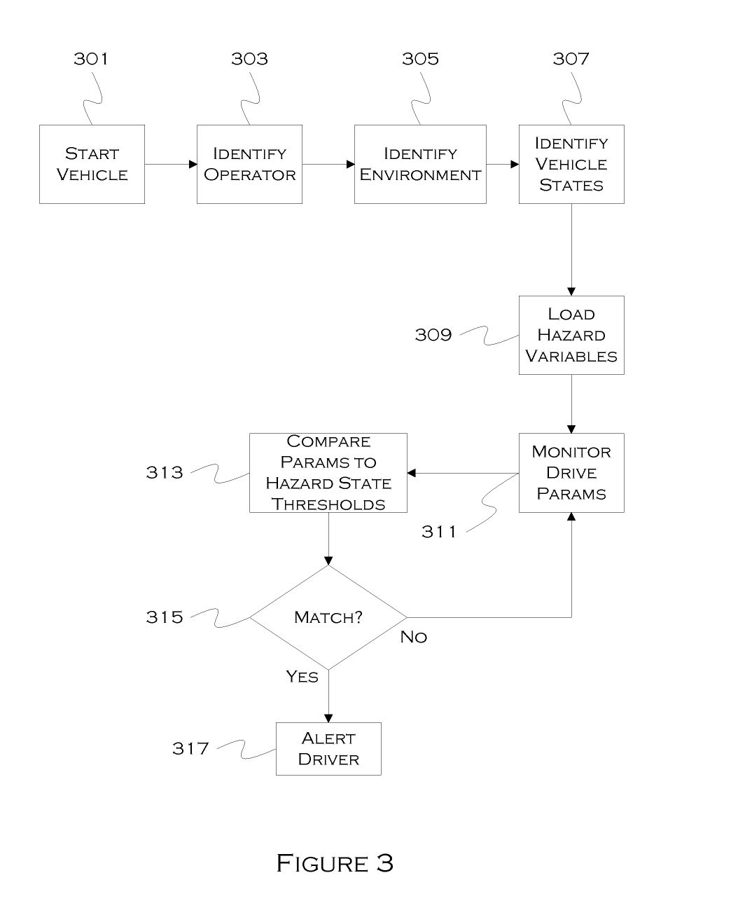

In the illustrative example shown in FIG. 3, a driver monitoring process is shown. In this example, driver states and vehicle states may be monitored to determine if an EDR triggering condition is imminent. Based on observed triggers for EDR recording (either generally or specific to that driver/vehicle), the process may observe vehicle state changes and determine if an onset of an EDR condition is likely.

With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, once the vehicle is started 301, the process will identify an operator 303, environmental variables 305 and vehicle states 307. This data will be used to compare against known variable conditions that may cause the onset of EDR recording conditions (identifying possible upcoming accidents).

Also, in this illustrative example, variables that may cause the onset of EDR recording conditions are loaded 309. These can be general variables (e.g., vehicle speed) or can be specific to a driver or vehicle. In some cases, general variables may have values associated with them based on a driver or vehicle, past which values it is observed that EDR recording states generally occur for a specific driver or vehicle. In other cases, the variables may have general threshold values associated therewith, past which EDR states generally occur.

For example, it may be observed that if the driver is Joe, an EDR state generally occurs with more than an inch of snowfall accumulated on the roads. So for that driver, the snowfall environmental variable may have a one inch threshold. Also, it may be observed that all drivers experience EDR states more commonly above eighty miles per hour, so a speed variable may have an 80 mph limit associated therewith.

Once all identifiers and variables (along with the appropriate thresholds) have been loaded, the process may being to monitor drive parameters 311. This can affect both the drive states of the vehicle, as well as environmental conditions in which the vehicle is driving. The process may also monitor driver awareness states, for example, if such monitoring is available.

Any and all of the monitored parameters may be compared to the thresholds associated with the hazard state variables 313. This data can be used to determine if any variable or variables indicates the likely onset of a pre-accident EDR recording state. If there is a match between the hazard state parameters and the variables 315, the process may alert the driver 317 of the variable thresholds that have been exceeded (for example, without limitation, “speed past safe threshold” or “snow accumulation may make driving dangerous”). If the driver can control the variable, the driver may move the state below the threshold in response, although in some instances the best the driver can do is to take additional precaution, since the driver cannot actually change the weather.

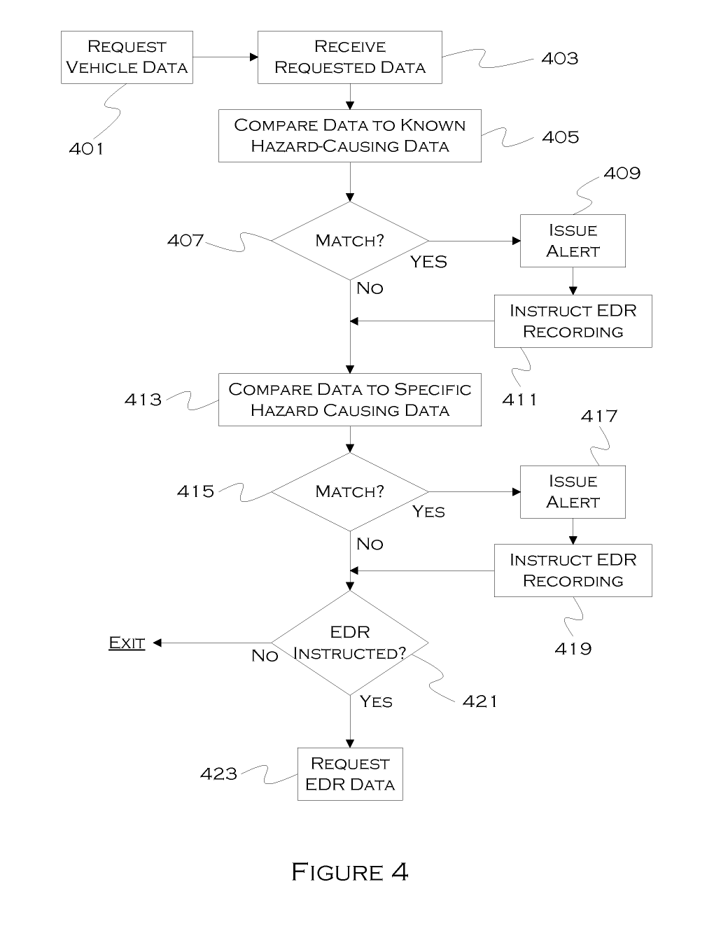

FIG. 4 shows an illustrative example of a cloud-based process for data analysis and EDR recording inception. In this illustrative example, a plurality of vehicles report to a cloud-based system, which performs variable analysis and can request EDR recording on demand, in case data for vehicles in certain states is desired for further analysis.

With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this example, the process will request vehicle data from one or more connected vehicles that are in communication with the remote system 401. For each vehicle from which the data was requested, the data is gathered and received 403. This data can include, but is not limited to, speed data, weather data, driver data, and generally any data that would be useful in analyzing likely upcoming EDR states or that may be useful in analyzing vehicle conditions leading to vehicle problems.

The gathered data can then be compared to thresholds for known EDR inception conditions in generally 405, which will tend to indicate whether or not the system is likely to trigger a condition under which EDR recording will occur. The general nature of the comparison here means that the data is compared to thresholds for all vehicles/drivers or for a class of vehicles/drivers.

If a match is found 407, indicating that an EDR state may be imminent based on the gathered data, the process may alert the driver 409. This could be in any suitable form, including, but not limited to, a visual warning, an audible warning, etc. A warning could also be issued to a fleet operator for the specific vehicle, if desired.

The process may also instruct EDR recording at the time the condition is detected 411. This can help preserve data to show what conditions occurred after the warning, and help determine if the driver took preventative actions or continued to drive in a similar manner. The data could also be useful for comparison to previously observed data, to show if issuing the warning was appropriate and/or reduced the likelihood of an actual accident, observable through the recorded EDR data. Since the actual EDR inception may be avoided by the issuance of the warning, it may be useful to see to what degree the actual changes in behavior occurred.

In addition to the general comparison, the process may also compare the received data to known variables that correspond to driver specific thresholds that trigger EDR recording for a specific driver or vehicle 413. This can help determine likely upcoming EDR recording states for a specific driver or vehicle.

If there is a match 415, the process will again issue an alert 417. The alert can be to the appropriate party and in the appropriate form(s). In addition to the alert issuance, the process can again instruct EDR recording 419, to gauge the driver's response to the alert.

In this process, if no EDR recording was instructed 421, the process will exit. If the EDR recording has been instructed, however, the process will request the recorded EDR data from the appropriate vehicle(s) and will store/analyze the data as appropriate, once the data has been received.

What follows are a number of EDR related scenarios utilizing the EDR data and preserved variables. These are for illustrative purposes only, and are not intended to limit the scope of the invention in any manner.

### Example 1

Actors: Telematics Control Unit (TCU)

Pre-conditions: TCU is awake and operating, TCU Configured to support 1-Wire with Driver ID.

Scenario Description: TCU will continuously monitor 1-wire network for connection of a driver identification device for a pre-determined and configurable duration after ignition transitions to the RUN/ON position. TCU will send alert and data when driver identification device is found.

Process:

1) After vehicle ignition transitions to RUN/ON; TCU will enable a fixed and configurable duration timer and continuously monitor for the application of a driver identification device on the 1-wire network

2) When TCU detects the connection of a 1-wire driver identification device, the TCU will issue a Driver Id alert and create the following data bundles: 1-Wire, VSTAT and GPS Info bundles

3) TCU will transmit the alert and data to ESB or web service.

4) If the TCU fails to read or detect a driver identification device prior to the expiration of the duration timer; the TCU will issue a Driver ID Failed alert which will also include VSTAT and GPS Info bundles.

5) TCU will issue failed alert and data bundles to ESB or web service.

Post-conditions: TCU is ready to detect another alert

Interfaces: OTA broadcast or download from cellular network, Vehicle Systems interface.

### Example 2

Actors: TCU Module.

Pre-conditions: TCU is awake and operating, TCU Configured to support 1-Wire with Temperature Sensor.

Scenario Description: At a pre-defined and configurable cadence, the TCU will periodically request 1-wire temperature sensors to provide data. The TCU will then issue an alert and send data to ESB or web service. The TCU will send a failure alert when any temperature sensor fails to respond to a request.

Steps:

1) TCU will periodically request temperature sensors connected to the 1-wire network to provide temperature data. Requests will be issued at a pre-determined and configurable rate.

2) Upon receipt of a response from temperature sensor; TCU will generate an alert and collect or form the following data bundles: 1-Wire, VSTAT and GPS Info bundles.

3) TCU will issue alert and data bundles to web service or ESB.

4) Failure to receive to receive a response from any temperature sensor connected to the 1-Wire network after a configurable number of re-tries; the TCU will issue a failed alert and include VSTAT and GPS Info bundles.

5) TCU will send failed alert and data bundles to web service or ESB

Post-conditions: TCU is ready to detect another alert

Interfaces: OTA broadcast or download from cellular network, Vehicle Systems interface.

### Example 3

Actors: TCU module.

Pre-conditions: TCU is awake and operating, TCU is configured to be ACTIVE TCU is configured to detect output events.

Scenario Description: TCU will continuously monitor the status of the external hardwired outputs during all TCU operating and power modes. When the TCU is commanded by ESB or web service or internally determines an output requires functioning. TCU will send alert and data to web service.

Steps:

1) Upon either the receipt of an OTA command issued by web service/ESB or the internal decision by the TCU to activate or deactivate an output. The TCU will form an output alert and collect the following data bundles VSTAT and GPS Info bundles.

2) TCU will issue alert and data bundles to web service or ESB.

3) Failure of the TCU to activate the TCU as required, the TCU will issue an output failure alert and VSTAT & GPS Info bundles.

4) TCU will issue failure alert and bundles to web service/ESB.

Post-conditions: Output Alert and data have been sent to web service, TCU is ready to detect another alert.

Interfaces: OTA broadcast or download from cellular network, Vehicle Systems interface.

### Example 4

Actors: TCU module.

Pre-conditions: TCU is awake and operational, TCU is configured to be active (Configured to provide alert . . . inactive:TCU does not provide alerts), TCU is configured to provide In-Vehicle Warnings.

Scenario Description: TCU will issue an alert to web service when TCU has executed an in-vehicle warning to the operator.

Steps:

1) Upon execution of an In-Vehicle warning TCU will issue alert to ESB or web service.

2) TCU will form the following data bundles: VSTAT & GPS Info bundles.

3) Failure of the TCU to execute the In-Vehicle Warning as required, the TCU will issue an In-Vehicle Warning failure alert and VSTAT & GPS Info bundles.

4) TCU will issue alert and bundles to web service/ESB.

Post-conditions: In_Vehicle Warning Alert and data have been sent to web service, TCU is ready to detect another alert.

Interfaces: OTA broadcast or download from cellular network, Vehicle Systems interface.

### Example 5

Actors: TCU Module.

Pre-conditions: TCU is operational, TCU is configured to be active.

Scenario Description: TCU will continuously monitor the status of all external hardwired inputs to TCU during all TCU operating and power modes. When the TCU detects a state change indicating an external device connected to the TCU'S input port has been activated or deactivated the TCU will send alert and data to web service.

Steps:

1) Upon detection of a state change on any hardwired input to TCU; TCU will issue an alert and collect the following data bundles: VSTAT and GPS Info

2) TCU will issue alert and data bundles to web service or ESB.

Post-conditions: Input alert code and vehicle snapshot data has been sent to web service, TCU is ready to detect another alert.

### Example 6

Actors: TCU Module.

Pre-conditions: TCU is awake and operating, Vehicle Ignition Status is on, accessory, or run, TCU has been configured to provide Driver Safety Alerts.

Scenario Description: TCU will monitor vehicle HSCAN network traffic or perform internal calculations or comparisons, when the TCU has determined a driver safety condition or event has begun or ended. TCU will generate a Driver Safety Alert and notify the service provider at the onset and termination of each event.

Steps:

1) TCU is configured to provide driver safety alerts.

2) As per requirement when the TCU detects the onset or termination of any safety or behavior related driving condition. The TCU will generate a Driver Safety Alert.

3) TCU will collect Driver Safety, VSTAT & GPS Info bundles.

4) TCU will create an alert code and data bundles and issue dataset to ESB or web service.

Post-conditions: TCU is ready to detect another alert, TCU has sent Driver Safety Alert, TCU has sent VSTAT Bundle, TCU has sent GPS Info & Driver Safety Bundle.

Interfaces: OTA broadcast or download from cellular network, Vehicle Systems interface.

### Example 7

Actors: TCU Module.

Pre-conditions: TCU is operational, Onboard and Offboard Clients are connected, TCU is configured to support output devices.

Scenario Description: Web service will issue command to TCU to activate or de-activate a hardwire TCU output. TCU will complete command and respond with a reply that details if command was successfully completed.

Steps:

1) Web service issues command to request TCU to activate or deactivate an output.

2) TCU will receive the command and execute the required procedures to activate or deactivate the TCU output.

3) Upon completion of the command or the attempted completion of the command the TCU will issue response message to the web service see Output Alert Use case.

Post-conditions: TCU is ready to detect another alert or command.

Interfaces: OTA broadcast or download from cellular network, Vehicle Systems interface.

### Example 8

Actors: TCU Module.

Pre-conditions: TCU is operational, Onboard and Off board Clients are connected, TCU is configured to support in vehicle warnings.

Scenario Description: Web service will issue command to TCU to activate an In-Vehicle warning to operator. TCU will complete command and respond with a reply that details if command was successfully completed.

Steps:

1) Web service issues command to request TCU to issue or cease an In-Vehicle warning.

2) TCU will receive the command and execute the required procedures to activate or de-activate the In-Vehicle warning.

3) Upon completion of the command or the attempted completion of the command the TCU will issue a response message to the web service see in-Vehicle Warning Alert Use Case

Post-conditions: TCU has issued warning and has replied back to the WEB services wither it was do or not.

Interfaces: OTA broadcast or download from cellular network, Vehicle Systems interface.

### Example 9

Actors: TCU Module.

Pre-conditions: TCU is operational, Onboard and Off board Clients are connected.

Scenario Description: Web service has issued a diagnostic command to TCU to execute a diagnostic service. TCU will complete command and respond with a reply indicating status of request and required data.

Steps:

1) Web service issues command to request TCU to execute diagnostic service.

2) TCU will execute diagnostic service contained in DiagDataFromCloud data bundle sent by web service or ESB.

3) Upon completion of the service request or the attempted completion of the service request the TCU will collect the diagnostic response from the targeted ECU.

4) TCU will package diagnostic response (s) in DiagDataFromVehicle data bundle.

5) TCU will issue a diagnostic data alert with DiagDataFromVehicle data bundle to the web service.

Post-conditions: TCU has replied to the web service with success or failure of web command, TCU has provide requested data to web service, TCU is ready to detect another alert or command.

Interfaces: OTA broadcast or download from cellular network, Vehicle Systems interface.

### Example 10

Actors: TCU Module.

Pre-conditions: TCU is operational, Onboard and Off board Clients are connected.

Scenario Description: Web service has issued a diagnostic command to TCU to repeatedly execute a diagnostic service. TCU will complete command and respond with a reply indicating status of request and required data. TCU will continue to execute the command at the specified cadence until the TCU receive a command to terminate the service request.

Steps:

1) Web service issues command to request TCU to execute diagnostic service.

2) TCU will execute diagnostic service contained in DiagDataFromCloud data bundle sent by web service or ESB.

3) Upon completion of the service request or the attempted completion of the service request the TCU will collect the diagnostic response from the targeted ECU.

4) TCU will package diagnostic response (s) in DiagDataFromVehicle data bundle.

5) TCU will issue a diagnostic data alert with DiagDataFromVehicle data bundle to the web service.

6) TCU will continue to re-execute diagnostic command at defined cadence as instructed by the ESB issued diagnostic command.

7) TCU will continue to execute diagnostic request until commanded by web service or ESB to terminate diagnostic requests.

Post-conditions: TCU has replied to the web service with success or failure of web command, TCU has provide requested data to web service, TCU is ready to detect another alert or command.

Interfaces: OTA broadcast or download from cellular network, Vehicle Systems interface.

### Example 11

Actors: TCU module.

Pre-conditions: TCU is awake and operating, Onboard and Off board Clients are connected, TCU is configured to be active.

Scenario Description: TCU has been commanded by ESB or has automatically performed a diagnostic service request to onboard modules. TCU has completed the requested or mandatory service and is returning the requested diagnostic data.

Steps:

1) TCU has performed requested or mandatory diagnostic service request.

2 TCU has received a diagnostic response from the targeted ECUs.

3) TCU repackages diagnostics responses into DiagDataFromVehicle bundle, and forms VSTAT and GOS Info bundles.

4) TCU will issue diagnostic data alert and bundles to web service/ESB.

Post-conditions: Output Alert and data have been sent to web service, TCU is ready to detect another alert.

Interfaces: OTA broadcast or download from cellular network, Vehicle Systems interface.

### Example 12

Actors: TCU Module.

Pre-conditions: TCU is operational, Onboard and Off board Clients are connected.

Scenario Description: Web service has issued cancel command to TCU to terminate the requested a diagnostic service. TCU will complete command and respond with a reply indicating status of request and required data.

Steps:

1) Web service issues command to request TCU to terminate previously requested diagnostic service.

2) TCU will execute commands.

3) Upon completion of the command or the attempted completion of the command the TCU will issue a diagnostic data alert a to the web service.

Post-conditions: TCU has replied to the web service with success or failure of web command, TCU has provide requested data to web service, TCU is ready to detect another alert or command.

Interfaces: OTA broadcast or download from cellular network, Vehicle Systems interface.

### Example 13

Actors: TCU Module.

Pre-conditions: TCU is operational, Onboard and Offboard Clients are connected, TCU is configured to support output devices.

Scenario Description: Web service will issue command to TCU to activate or de-activate a hardwire TCU output. TCU will complete command and respond with a reply that details if command was successfully completed.

Steps:

1) Web service issues command to request TCU to activate or deactivate an output.

2) TCU will receive the command and execute the required procedures to activate or deactivate the TCU output.

3) Upon completion of the command or the attempted completion of the command the TCU will issue response message to the web service see Output Alert Use case.

Post-conditions: TCU is ready to detect another alert or command.

Interfaces: OTA broadcast or download from cellular network, Vehicle Systems interface

### Example 14

Actors: TCU Module.

Pre-conditions: TCU is operational, Onboard and Off board Clients are connected, TCU is configured to support in vehicle warnings

Scenario Description: Web service will issue command to TCU to activate an In-Vehicle warning to operator. TCU will complete command and respond with a reply that details if command was successfully completed.

Steps:

1) Web service issues command to request TCU to issue or cease an In-Vehicle warning.

2) TCU will receive the command and execute the required procedures to activate or de-activate the In-Vehicle warning.

3) Upon completion of the command or the attempted completion of the command the TCU will issue a response message to the web service see in-Vehicle Warning Alert Use Case.

Post-conditions: TCU has issued warning and has replied back to the WEB services wither it was do or not.

Interfaces: OTA broadcast or download from cellular network, Vehicle Systems interface.

### Example 15

Actors: TCU Module.

Pre-conditions: TCU is operational, Onboard and Off board Clients are connected.

Scenario Description: Web service has issued a diagnostic command to TCU to execute a diagnostic service. TCU will complete command and respond with a reply indicating status of request and required data.

Steps:

1) Web service issues command to request TCU to execute diagnostic service.

2) TCU will execute diagnostic service contained in DiagDataFromCloud data bundle sent by web service or ESB.

3) Upon completion of the service request or the attempted completion of the service request the TCU will collect the diagnostic response from the targeted ECU.

4) TCU will package diagnostic response (s) in DiagDataFromVehicle data bundle.

5) TCU will issue a diagnostic data alert with DiagDataFromVehicle data bundle to the web service.

Post-conditions: TCU has replied to the web service with success or failure of web command, TCU has provide requested data to web service, TCU is ready to detect another alert or command.

Interfaces: OTA broadcast or download from cellular network, Vehicle Systems interface

### Example 16

Actors: TCU Module.

Pre-conditions: TCU is operational, Onboard and Off board Clients are connected.

Scenario Description: Web service has issued a diagnostic command to TCU to repeatedly execute a diagnostic service. TCU will complete command and respond with a reply indicating status of request and required data. TCU will continue to execute the command at the specified cadence until the TCU receive a command to terminate the service request.

Steps:

1) Web service issues command to request TCU to execute diagnostic service.

2) TCU will execute diagnostic service contained in DiagDataFromCloud data bundle sent by web service or ESB.

3) Upon completion of the service request or the attempted completion of the service request the TCU will collect the diagnostic response from the targeted ECU.

4) TCU will package diagnostic response (s) in DiagDataFromVehicle data bundle.

5) TCU will issue a diagnostic data alert with DiagDataFromVehicle data bundle to the web service.

6) TCU will continue to re-execute diagnostic command at defined cadence as instructed by the ESB issued diagnostic command.

7) TCU will continue to execute diagnostic request until commanded by web service or ESB to terminate diagnostic requests.

Post-conditions: TCU has replied to the web service with success or failure of web command, TCU has provide requested data to web service, TCU is ready to detect another alert or command.

Interfaces: OTA broadcast or download from cellular network, Vehicle Systems interface.

### Example 17

Actors: TCU module.

Pre-conditions: TCU is awake and operating, Onboard and Off board Clients are connected, TCU is configured to be active.

Scenario Description: TCU has been commanded by ESB or has automatically performed a diagnostic service request to onboard modules. TCU has completed the requested or mandatory service and is returning the requested diagnostic data.

Steps:

1) TCU has performed requested or mandatory diagnostic service request

2 TCU has received a diagnostic response from the targeted ECUs.

3) TCU repackages diagnostics responses into DiagDataFromVehicle bundle, and forms VSTAT and GOS Info bundles.

4) TCU will issue diagnostic data alert and bundles to web service/ESB.

Post-conditions: Output Alert and data have been sent to web service, TCU is ready to detect another alert.

Interfaces: OTA broadcast or download from cellular network, Vehicle Systems interface.

### Example 18

Actors: TCU Module.

Pre-conditions: TCU is operational, Onboard and Off board Clients are connected.

Scenario Description: Web service has issued cancel command to TCU to terminate the requested a diagnostic service. TCU will complete command and respond with a reply indicating status of request and required data.

Steps:

1) Web service issues command to request TCU to terminate previously requested diagnostic service.

2) TCU will execute commands.

3) Upon completion of the command or the attempted completion of the command the TCU will issue a diagnostic data alert to the web service.

Post-conditions: TCU has replied to the web service with success or failure of web command, TCU has provide requested data to web service, TCU is ready to detect another alert or command.

Interfaces: OTA broadcast or download from cellular network, Vehicle Systems interface.

### Example 19

Actors: TCU Module.

Pre-conditions: Vehicle Ignition Status is on, accessory, or run, TCU has been configured to provide Driver Warning Alerts, Powertrain is running, All FMVSS required bulb checks have been completed.

Scenario Description: TCU has determined a driver warning is being displayed to the driver. TCU will generate a Driver Warning Alert and notify the service provider at the initiation and termination of any warning displayed to the driver.

Steps:

1) TCUs is configured to provide driver warning alerts.

2) When the TCU detects a state change or level change in any monitored warning. The TCU will issue a driver warning alert.

3) TCU will collect VSTAT & GPS Info bundle.

4) TCU will assembled DRIVER WARNING bundle.

5) TCU will assembled TRIP REPORT bundle.

6) TCU will create and issue alert with data bundles to ESB or web service.

Post-conditions: TCU is ready to detect another alert, TCU has issued Driver Warning Alert.

Interfaces: OTA broadcast or download from cellular network, Vehicle Systems interface.

### Example 20

Actors: TCU module.

Pre-conditions: TCU is operational, TCU is configured to be active.

Scenario Description: TCU will monitor vehicle speed. When the vehicle speed has risen above a configurable vehicle speed setting for a configurable duration of time. The TCU will issue a MOVING AFTER STOPPED alert.

Steps:

1) TCU will determine vehicle speed.

2) If vehicle speed>STOPPED SPEED configuration, TCU will begin After Stopped Duration Timer.

3) If After Stopped Duration Timer>AFTER STOP TIME configuration, TCU will register MOVING AFTER STOPPED alert.

4) TCU will collect VSTAT & GPS Info.

5) TCU will collect TRIP REPORT bundle.

6) TCU will collect DRIVER WARNING bundle.

7) TCU will create and issue a MQTT dataset with appropriate MQTT header with alert code, data bundles, and correlation ID as payload.

8) TCU will issue dataset alert and data bundles to web service.

Post-conditions: MOVING AFTER STOPPED Alert and data have been sent to web service, TCU is ready to detect another alert.

Interfaces: OTA broadcast or download from cellular network, Vehicle Systems interface.

### Example 21

Actors: TCU Module.

Pre-conditions: TCU is operational, TCU is configured to be active.

Scenario Description: TCU will monitor vehicle speed. When vehicle speed has dropped below a configurable vehicle speed setting for a configurable duration of time. The TCU will issue a STOPPED alert.

Steps:

1) TCU will determine vehicle speed.

2) If vehicle speed<STOPPED SPEED configuration, TCU will begin Stopped Duration Timer.

3) If Stopped Duration Timer>STOP TIME configuration, TCU will register STOPPED alert code.

4) TCU will collect VSTAT & GPS Info.

5) TCU will collect TRIP REPORT bundle.

6) TCU will collect DRIVER WARNING bundle.

7) TCU will create and issue a MQTT dataset with appropriate MQTT header with alert code, data bundles, and correlation ID as payloadTCu will issue alerts and data bundles to web service.

Post-conditions: STOPPED Alert and data have been sent to web service, TCU is ready to detect another alert.

Interfaces: OTA broadcast or download from cellular network, Vehicle System Interface.

### Example 22

Actors: TCU module.

Pre-conditions: TCU is operational, TCU is configured to be active, Time Trip Report time counter has expired.

Scenario Description: When the TCU's configurable Trip Report or major alert time configurable counter has expired. The TCU registers a Trip Report alert collects and then sends alert code and VSTAT & GPS Info data to web service.

Steps:

1) TCUs configurable Trip Report (Major) periodic alert timer limit has been exceeded or expired.

2) TCU will register Trip Report (15 min) alert.

3) TCU will collect VSTAT & GPS Info.

4) TCU will collect TRIP REPORT bundle.

5) TCU will collect DRIVER WARNING bundle.

6) TCU will reset timer or counter.

7) TCU will create and issue a MQTT dataset with appropriate MQTT header with alert code, data bundle, and correlation ID as payload.

8) TCU will issue dataset alert and data bundles to web service.

Post-conditions: Trip Report Periodic Alert and data have been sent to web service, TCU is ready to detect another alert.

Interfaces: OTA broadcast or download from cellular network, Vehicle Systems Interface.

### Example 23

Actors: TCU Module.

Pre-conditions: TCU is operational, TCU is configured to be active, minor or short Time counter has expired.

Scenario Description: When the TCU's configurable minor timer has expired. The TCU registers a Minor Event alert collects and then sends alert code and VSTAT & GPS data to web service.

Steps:

1) TCU's configurable Vehicle Status alert timed based counter has expired.

2) TCU will register Minor alert code.

3) TCU will collect VSTAT & GPS Info bundles.

4) TCU will reset alert counter or timer.

5) TCU will create and issue a MQTT dataset with appropriate MQTT header with alert code, data bundle, and correlation ID as payload.

6) TCU will issue dataset alert and data bundles to web service.

Post-conditions: Vehicle Status (2 min) Alert and data have been sent to web service, TCU is ready to detect another alert.

Interfaces: OTA broadcast or download from cellular network, Vehicle System Interface.

### Example 24

Actors: TCU Module.

Pre-conditions: TCU is operational, TCU is configured to be active, minor or short Time counter has expired.

Scenario Description: When the TCU's configurable minor timer has expired. The TCU registers a Minor Event alert collects and then sends alert code and VSTAT & GPS data to web service.

Steps:

1) TCU's configurable Vehicle Status alert timed based counter has expired.

2) TCU will register Minor alert code.

3) TCU will collect VSTAT & GPS Info bundles.

4) TCU will reset alert counter or timer.

5) TCU will create and issue a MQTT dataset with appropriate MQTT header with alert code, data bundle, and correlation ID as payload.

6) TCU will issue dataset alert and data bundles to web service.

Post-conditions: Vehicle Status (2 min) Alert and data have been sent to web service, TCU is ready to detect another alert.

Interfaces: OTA broadcast or download from cellular network, Vehicle System Interface.

### Example 25

Actors: TCU module.

Pre-conditions: TCU is operational, TCU is configured to be active.

Scenario Description: The TCU will determine the powertrain has transitioned to an enabled or operating state and send an EngON Alert with data bundles.

Steps:

1) TCU will determine powertrain Engine state as active.

2) BEV & HEV: TCU will determine engine state as active.

3) TCU will issue EngOn alert.

4) TCU will collect VSTAT & GPS Info.

5) TCU will collect TRIP REPORT bundle.

6) TCU will collect DRIVER WARNING bundle.

7) TCU will create and issue a MQTT dataset with appropriate MQTT header with alert code, data bundles, and correlation ID as payload.

8) TCU will issue dataset alert and data bundles to web service.

Post-conditions: EngON alert and data bundles have been sent to web service, TCU is ready to detect another alert.

Interfaces: OTA broadcast or download from cellular network, Vehicle Systems Interface.

### Example 26

Actors: TCU Module.

Pre-conditions: TCU is operational, TCU is configured to be active.

Scenario Description: The TCU will determine the powertrain has transitioned to an off or non-operating state. TCU will send an EngOFF Alert with data bundles.

Steps:

1) TCU will determine Engine is not operating.

2) BEV & HEV: TCU will determine powertrain OFF.

3) TCU will issue EGN Off alert code.

4) TCU will collect VSTAT & GPS Info.

5) TCU will collect TRIP REPORT bundle.

6) TCU will collect DRIVER WARNING bundle.

7) TCU will create and issue a MQTT dataset with appropriate MQTT header with alert code, data bundles, and correlation ID as payload.

8) TTCU will issue data setalert and data bundles to web service.

Post-conditions: Engine operating mode is OFF or non-operating state, EGNOFF alert code and data has been sent to web service, TCU is waiting to detect additional alert conditions.

Interfaces: OTA broadcast or download from cellular network, Vehicle Systems interfaces.

### Example 27

Actors: TCU module.

Pre-conditions: Ignition status Run, TCU is operational, TCU is configured to be active.

Scenario Description: When the vehicle transitions to the to the off or non-operating state from any other operating state, TCU registers an Ign Off alert collects then sends alert code and VSTAT & GPS Info data to web service.

Steps:

1) TCU will determine ignition state.

2) Upon transition from any other state to Ignition OFF, TCU will send alert.

3) TCU will issue IGN Off alert.

4) TCU will collect VSTAT & GPS Info.

5) TCU will create and issue a MQTT dataset with appropriate MQTT header with alert code, VSTAT & GPSInfo, and correlation ID as payload.

6) TTCU will transmit data setalert and data bundles to web service.

Post-conditions: IgnOFF alert code and Vehicle Snapshot & GPS data has been sent to web service, TCU is ready to detect another alert or event.

Interfaces: OTS broadcast or download over cellular network, Vehicle Systems Interface.

### Example 28

Actors: TCU module.

Pre-conditions: Ignition is Off, TCU is operational, TCU is configured to be active.

Scenario Description: When the vehicle transitions from the off or non-operating state to any other operating state, TCU registers Ign Run alert collects then sends alert code and VSTAT & GPSInfo data to web service.

Steps:

1) TCU will determine ignition state.

2) Upon transition from any other ignition state to Ignition=RUN or accessory, TCU will send alert.

3) TCU will issue IGN run alert code and will collect VSTAT & GPS Info.

4) TCU will create and issue a MQTT dataset with appropriate MQTT header with alert code, VSTAT & GPSInfo, and correlation ID as payload.

5) TTCU will issue data alert and data bundles set to web service.

Post-conditions: IgnRun alert code and VSTAT & GPS Bundle data has been sent to web service, TCU is ready to detect another alert or event.

Interfaces: OTA upload/download (cellular connection), Vehicle Systems interface.

### Example 29

Actors: TCU Module.

Pre-conditions: TCU is awake and in Full or Low Power Mode.

Scenario Description: When the TCU detects conditions indicating the GPS has achieved a GPS dimension level of 3D. The TCU will issue a GPS 3D FIX alert.

Steps:

1) The TCU will monitor the HSCAN signals provided by the GPSM module or equivalent signals provided by an internal or dedicated GPS antenna.

2) TCU will monitor GPS Dimension Info.

3) GPS_dimension=3D fix, TCU will register GPS 3D FIX alert code.

4) TCU will collect VSTAT & GPS Info.

5) TCU will create and issue a MQTT dataset with appropriate MQTT header with alert code, VSTAT & GPSInfo, and correlation ID as payload, issue alert and data bundles to web service.

Post-conditions: TCU is ready to detect another alert.

### Example 30

Actors: TCU Module.

Pre-conditions: TCU is operational, TCU is configured to provide police alerts, Lateral Acceleration exceeds 8 m/s², or Brake Torque exceeds 5000 Nm, monitoring device with send alert that vehicle has entered “Pursuit Mode”, TCU is configured to be ACTIVE (Configured to provide alert . . . INACTIVE:TCU does not provide alerts), Vehicle has entered Pursuit mode.

Scenario Description: In Police Vehicles only; TCU is configured to support police vehicle options. After TCU has detected a pursuit mode condition, TCU will issue a police pursuit mode alert and continue to issue a pursuit mode alerts every 5 seconds until conditions indicate pursuit mode has ended.

Steps:

1) TCU will monitor lateral acceleration and brake torque data.

2) When lateral acceleration exceeds 8/m/s² or brake torque exceed 5000 Nm; TCU will issue a pursuit mode alert and start a 45 second timer.

3) TCU will collect VSTAT and GPS Info bundles and send these bundles with every pursuit mode alert the TCU issues.

4) TCU will issue alert and data bundles to web service.

5) Pursuit mode alerts will be continuously be re-issued every 5 seconds with updated VSTAT and GPS Info bundles and issued to the web service until the 45 second timer terminates.

6) If TCU experiences lateral acceleration above 8 m/s² or brake torque in excess of 5000 Nm prior to the expiration of the 45 second timer; the timer will be reset and pursuit mode alerts will continue for an additional 45 seconds.

Post-conditions: Police Pursuit Mode Alert and data have been sent to web service, TCU is ready to detect another alert.

Interfaces: OTA broadcast or download from cellular network, Vehicle System Interface.

### Example 31

Actors: TCU Module.

Pre-conditions: TCU is operational, TCU is configured to be active, TCU configured to support Police features, TCU has a input port configured to support police siren.

Scenario Description: In Police Vehicles only; TCU is configured to support police vehicle options. After TCU has detected a police siren has been activated by monitoring designated or configured input ports, TCU will issue SIREN ON alert to the web service.

Steps:

1) TCU has determined the police siren has been activated.

2) TCU will issue a SIREN ON alert with data bundles.

3) TCU will collect Vehicle Status or VSTAT and GPS info bundles with all alerts.

4) TCU will issue alert and dataset to web service.

Post-conditions: Police Siren On Alert and data have been sent to web service, TCU is ready to detect another alert.

Interfaces: OTA broadcast or download from cellular network, Vehicle System Interface.

### Example 32

Actors: TCU Module.

Pre-conditions: TCU is operational, TCU is configured to be active, TCU configured to support Police features, TCU has a input port configured to support police siren.

Scenario Description: In Police Vehicles only; TCU is configured to support police vehicle options. After TCU has detected a police siren has been deactivated by monitoring designated or configured input ports, TCU will issue SIREN OFF alert to the web service.

Steps:

1) TCU has determined the police siren has been deactivated.

2) TCU will issue a SIREN OFF alert with data bundles.

3) TCU will collect VSTAT and GPS Info bundles with all alerts.

4) TCU will issue alert and data bundles dataset to web service.

Post-conditions: Police Siren Off Alert and data have been sent to web service, TCU is ready to detect another alert

Interfaces: OTA broadcast or download from cellular network, Vehicle System Interface.

### Example 33

Actors: TCU Module.

Pre-conditions: TCU is operational, TCU is configured to be active, TCU configured to support Police features, TCU has a input port configured to support police light bar.

Scenario Description: In Police Vehicles only; TCU is configured to support police vehicle options. After TCU has detected a police light bar has been activated by monitoring designated or configured input ports, TCU will issue LIGHTBAR ON alert to the web service.

Steps:

1) TCU has determined the police light bar has been activated.

2) TCU will issue a LIGHT BAR ON alert with data bundles.

3) TCU will collect VSTAT and GPS Info bundles with all alerts.

4) TCU will issue dataset alert and data bundles to web service.

Post-conditions: Police Light Bar On Alert and data have been sent to web service, TCU is ready to detect another alert.

Interfaces: OTA broadcast or download from cellular network, Vehicle System Interface.

### Example 34

Actors: TCU Module.

Pre-conditions: TCU is operational, TCU is configured to be active, TCU configured to support Police features, TCU has a input port configured to support police light bar.

Scenario Description: In Police Vehicles only; TCU is configured to support police vehicle options. After TCU has detected a police light bar has been deactivated by monitoring designated and configured input ports, TCU will issue Light Bar OFF alert to the web service.

Steps:

1) TCU has determined the police siren has been deactivated.

2) TCU will issue a Light bar OFF alert with data bundles.

3) TCU will collect VSTAT and GPS Info bundles with all alerts.

4) TCU will issue dataset alert and data bundles to web service.

Post-conditions: Police Light Bar OFF Alert and data have been sent to web service, TCU is ready to detect another alert.

Interfaces: OTA broadcast or download from cellular network, Vehicle System Interface.

### Example 35

Actors: TCU Module.

Pre-conditions: TCU is operational, EDRTriggerEvntSyncLateral has triggered, TCU is configured to be active.

Scenario Description: In Police Vehicles only; TCU is configured to support police vehicle options. After TCU has detected a EDRTriggerEvntSync transition to active, TCU will issue a police EDR alert.

Steps:

1) TCU has determined the vehicle is experiencing conditions to cause an EDR event.

2) TCU will issue a EDR alert with data bundles.

3) TCU will collect VSTAT and GPS Info bundles and send these bundles with every EDR alert the TCU issues.

4) TCU will issue alert and data bundles to web service.

5) EDR alerts will be continuously be re-issued every 5 seconds with updated VSTAT and GPS Info bundles and issued to the web service until the 45 second timer terminates.

6) If TCU experiences additional EDR events prior to the expiration of the 45 second timer; the timer will be reset and EDR alerts will continue for an additional 45 seconds.

Post-conditions: Police EDR Alert and data have been sent to web service, TCU is ready to detect another alert.

Interfaces: OTA broadcast or download from cellular network, Vehicle System Interface.

### Example 36

Actors: TCU Module.

Pre-conditions: TCU is operational, TCU has ACTIVE state enabled, Ignition is in the KEY OFF position, TCU has transitioned to low or sleep power mode.

Scenario Description: TCU will periodically wake from low or sleep power mode according to configurable timer. The default time or value will be 12 hours. Upon waking the TCU will acquire GPS and vehicle data, establish a MQTT connection and transmit data to the ESB or web service. Upon completion, the TCU will return to low or sleep power mode.

Steps:

1. TCU sleep timer has expired.

2. TCU wakes vehicle bus to acquires GPS and vehicle data.

3. TCU forms VSTAT and GPS info bundles.

4. TCU establishes an MQTT connection to ESB or web service.

5. TCU issues datasets to ESB or web service.

6. TCU re-enters low or sleep power mode.

Post-conditions: TCU returns to low or sleep power mode and waits for vehicle alert conditions.

Interfaces: OTA broadcast or download from cellular network, Vehicle System Interface.

### Example 37

Actors: TCU Module.

Pre-conditions: TCU is operational, TCU is configured to issue a generic alert, TCU has been configured to associate a HSCAN signal and data required to issue the generic alert, TCU is configured to be active.

Scenario Description: The TCU has been configured to issue generic alerts. The TCU has determined the configured HSCAN signal has transitioned to a state requiring an alert to be issued. The TCU will issue alert with the required data bundles.

Steps:

1. TCU has determined the vehicle is experiencing conditions to cause a generic alert to be issued.

2. TCU will issue a generic alert # with data bundles.

3. TCU will collect VSTAT & GPS Info.

4. TCU will issue generic alert and data bundles to web service.

Post-conditions: Generic # Alert and data have been sent to web service, TCU is ready to detect another alert.

Interfaces: OTA broadcast or download from cellular network, Vehicle System Interface.

### Example 38

Actors: TCU Module.

Pre-conditions: TCU is operational, TCU is configured to stream HSCAN frames, TCU is configured to stream selected HSCAN frames, TCU is configured to be active, TCU has active connection to ESB or web service.

Scenario Description: The TCU has been configured to enable the TCU to stream vehicle data in real time as the data is received on the vehicle HSCAN network. In this mode the TCU will receive HSCAN messages and load the un-processed HSCAN frames as a MQTT payload for transmission to the web service or ESB.

Steps:

1. TCU establishes an MQTT connection to ESB or web service.

2. TCU will receive designated HSCAN messages from vehicle HSCAN network

3. TCU will store 30 seconds increments of continuous HSCAN data

4. TCU will issue a CANNET alert and bundle 30 second interval of HSCAN data into a SVHSCAN bundle and broadcast or issue alert data to web service

5. TCU will continuously store, bundle and issue HSCAN data to webservice

Post-conditions: Data has been successfully received by the ESB or web service.

Interfaces: OTA broadcast or download from cellular network, Vehicle System Interface.

### Example 39

Actors: TCU module

Pre-conditions: TCU is operational, ESB is operational, TCU has a default configuration as inactive, TCU has a default configuration as unauthorized.

Scenario Description: TCU has been installed in a vehicle by field installer. TCU determines either the power mode or VIN has changed. TCU establishes a cellular connection and issues authorization request to service provider.

Steps:

1) After power is applied to the TCU, the TCU will establish a cellular connection to ESB, MQTT message broker or web service.

2) If TCU determines either the power mode is “Power first Applied” or the TCU detects a new VIN. TCU will revert to default configuration. TCU must issue an Authorization Request to ESB.

3) TCU will set Provisioning reason flag to “Power first Applied” or ‘New VIN” in provisioning bundle as required by conditions.

4) TCU will send Authorization Request with Provisioning Bundle, VSTAT Bundle, & GPS Info Bundle to web service.

5) ESB processes Authorization Request.

6) ESB sends diagnostic command with configuration data to change TCU operating state to ACTIVE, and TCU authorization state as AUTHORIZED.

Post-conditions: TCU will immediately send TCU Configuration Request and Vehicle Content Query Request, per use case and requirements to ESB, TCU status is now active and authorized.

Interfaces: OTA broadcast or download from cellular network, Vehicle Systems interface.

### Example 40

Actors: TCU Module.

Pre-conditions: TCU is active and awake, TCU has completed Authorization Request.

Scenario Description: TCU will send request to web service, requesting the ESB or web service to issue diagnostic commands to TCU to query other modules or ECUs to determine vehicle feature and content required to support Crew Chief features.

Steps:

1) TCU will initiate a Vehicle Content Query Request to ESB or Web service.

2) TCU will send request along with Provisioning Bundle, VSTAT Bundle and GPS Info bundle to ESB.

3) ESB will send diagnostic command to TCU to query modules.

4) Vehicle Modules respond to TCU query with diagnostic data.

5) TCU sends diagnostic data to ESB.

6) ESB continues sending diagnostic commands to TCU to query modules until the ESB collects configuration data from all the required modules.

7) ESB process vehicle configuration data to determine TCU configuration.

Post-conditions: TCU is ready to accept TCU configuration command detect another alert.

Interfaces: OTA broadcast or download from cellular network, Vehicle Systems interface.

### Example 41

Actors: TCU Module.

Pre-conditions: TCU is active and awake.

Scenario Description: TCU will check configuration status; if the TCU has not been configured TCU will issue a TCU Configuration Request to ESB per requirements after every Ignition On Alert.

Steps:

1) If TCU has not been configured, TCU will send TCU Configuration request with Provisioning Bundle, VSTAT Bundle and GPS Info Bundle to ESB.

2) ESB will process configuration request and send diagnostic command with configuration data to TCU.

3) TCU will process diagnostic command and write configuration data to correct locations.

4) Upon completion of configuration write, TCU will read stored configuration data and send data to ESB as a diagnostic bundle.

5) ESB will receive diagnostic data from TCU, confirm correct configuration has been processed.

6) ESB issues diagnostic command to TCU to clear all diagnostic trouble codes

Post-conditions: TCU is ready to detect another alert, TCU is ready for another command, TCU configuration not complete alert code has been sent.

Interfaces: OTA broadcast or download from cellular network, Vehicle Systems interface.

### Example 42

Actors: TCU Module.

Pre-conditions: TCU is operational, TCU is awake.

Scenario Description: TCU has detected conditions that indicate a PROVISIONING alert is required to be issued to the ESB or web service.

Steps:

1) TCU has encountered a condition that requires the issuing of Reset/Provisioning Alert.

2) TCU will register Provisioning Alert.

3) TCU will collect VSTAT & GPS Info Bundles.

4) TCU will collect a PROVISIONING bundle (includes reason for alert).

Post-conditions: TCU is ready to detect another alert.

### Example 43

Actors: TCU Module.

Pre-conditions: TCU active, TCU reading HSCAN messages, After Market tool is connected.

Scenario Description: TCU will continuously monitor HSCAN traffic when the TCU detects HSCAN traffic indicating a service tool is connected to the bus. The TCU will issue a Tester Present alert to the web service.

Steps:

1) TCU recognizes that a tester tool is connected to HS CAN.

2) TCU will issue Tester Present alert code.

3) TCU will collect VSTAT & GPS Info Bundles.

Post-conditions: TCU is ready to detect another alert.

### Example 44

Actors: TCU Module.

Pre-conditions: TCU is operational, TCU has under gone first power applied event OR TCU reads new VIN, TCU has established MQTT connection to webservice, TCU issued Provisioning GPS Info & VSTAT Bundle, TCU has completed the Authorization process.

Scenario Description: TCU has successful powered up and has established a MQTT connection to ESB message broker. TCU will issue a diagnostic command/request to BCM to execute a self-test diagnostics routine. This will give the installer an indication the TCU has been correctly installed.

Steps:

1. TCU issues a Service 0x31 with Routine Identifier 0x0202 to BCM.

2. BCM receives diagnostics command.

3. BCM executes command.

4. TCU reads diagnostic command response from BCM.

5. Positive response received, command executed; TCU sends diagnostic alert and diagnostic bundle to ESB or web service.

6. Negative response received, command not executed; TCU sends diagnostic alert and diagnostic data bundle to ESB or web service.

Post-conditions: BCM self-test executed, TCU begins monitoring vehicle for alert conditions.

Interfaces: OTA broadcast or download from cellular network, Vehicle System Interface.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A system comprising:
a processor configured to:
detect a threat condition indicating that event data recording (EDR) should begin;
begin and continue event data recording for a predetermined amount of time following the condition;
if the predetermined amount of time has passed, and no severe incident has been detected, save data recorded by the event data recording; and
upload the saved data to a remote system once a connection with the remote system can be established.

2. The system of claim 1, wherein the condition is predefined by a manufacturer.

3. The system of claim 1, wherein the condition is indicative of an upcoming accident.

4. The system of claim 1, wherein the remote system is an automotive manufacturer server.

5. The system of claim 1, wherein the remote system is a fleet management server.

6. The system of claim 1, wherein the condition relates to a vehicle braking state.

7. The system of claim 1, wherein the condition relates to a vehicle movement state.

8. The system of claim 1, wherein the condition relates to a vehicle change in speed.

9. A system comprising:
a processor configured to:
receive variable input data from a plurality of wirelessly connected vehicles;
compare the received variable input data to predetermined thresholds to determine if a condition likely to initiate event data recording (EDR) is imminent in any of the plurality of vehicles;
for each vehicle in which the condition is imminent, issue an instruction for the vehicle to warn a vehicle driver;
issue a request to each vehicle for which the condition is imminent, requesting event data recording; and
gather data recorded by the requested event data recording(s).

10. The system of claim 9, wherein the warning is a visual warning.

11. The system of claim 9, wherein the warning is an audio warning.

12. The system of claim 9, wherein the processor is also configured to issue a warning to a fleet operator.

13. The system of claim 9, wherein the data is gathered while the recording is ongoing.

14. The system of claim 9, wherein the data is gathered following the event data recording.

15. A computer-implemented method comprising:
detecting a threat condition indicating that event data recording (EDR) should begin;
beginning and continuing event data recording for a predetermined amount of time following the condition;
if the predetermined amount of time has passed, and no severe incident has been detected, saving data recorded by the event data recording; and
uploading the saved data to a remote system once a connection with the remote system can be established.

16. The method of claim 15, wherein the condition is predefined by a manufacturer.

17. The method of claim 15, wherein the condition is indicative of an upcoming accident.

18. The method of claim 15, wherein the remote system is an automotive manufacturer server.

19. The method of claim 15, wherein the remote system is a fleet management server.
